(19) United States
(12) Patent Application Publication
(10) Pub. No.: US 2009/0064609 A1
(43) Pub. Date: Mar. 12, 2009

(54) Retrofit system for doors, windows and framed openings

(76) Inventors: Tianhong Ouyang, Chapel Hill, NC (US); Kenneth L. Robinson, Zebulon, NC (US); Bobby A. Stocks, Elm City, NC (US)

Correspondence Address: Melvin I. Stoltz, 51 Cherry Street, Milford, CT, 06460, US

(21) Appl. No.: 12/229,427

(22) Filed: Aug. 21, 2008

Related U.S. Application Data
(60) Provisional application No. 60/993,512, filed on Sep. 11, 2007.

(51) Int. Cl. E06B 1/34

(52) U.S. Cl. 52/211

(57) ABSTRACT

By providing a plurality of supporting clips which are quickly and easily mounted to the existing molding of a doorway or window frame and are constructed for receiving and supportingly retaining elongated, longitudinally extending decorative panels which are formed from a wide variety of decorative and visually distinctive appearances, a retrofit decorative molding system is achieved which is capable of being quickly and easily installed to any desired existing frame assembly by any unskilled individual, without requiring the use of mitered corners, abutting junctures, nails, adhesives, and the like. In addition, corner forming elements are employed to complete the construction. Furthermore, disassembly or removal of the existing components is required. By employing the combination of the components of the present invention, any desired frame assembly can be quickly and easily retrofitted with a completely installed decorative molding system for enhancing the visual and aesthetic appeal of any room or building.

### RELATED APPLICATIONS

This application is related to U.S. Provisional Patent Application Ser. No. 60/993,512, filed Sep. 11, 2007 entitled RETROFIT SYSTEM FOR DOORS, WINDOWS AND FRAMED OPENINGS.

### TECHNICAL FIELD

This invention relates to molding systems for installation in homes, offices, and other buildings and, more particularly, to retrofit decorative molding systems which are quickly and easily mounted in position directly over existing molding elements without requiring the use of adhesives, nails, other similar fastening elements.

### BACKGROUND ART

Individuals are continuously upgrading their residences and/or offices in order to improve the visual appeal of their homes or businesses. Frequently, these upgrades include decorative or aesthetic improvements or enhancements which are employed for making homes/businesses more visually attractive both for the owner as well as for resale of the home/business. In addition, similar improvements or enhancements are also employed by home/business builders in order to impart greater interest and excitement to a newly built home/business to enable the home/business to be more attractive and saleable.

Although these improvements and enhancements may take many different forms, frequently, owners and builders add decorative features to a home/business which involve moldings, such as casement moldings, employed about doors, windows, entryways, and the like, as well as accent molding, ceiling molding or lineal segments mounted along the juncture between a wall and ceiling, along the perimeter of the room, such as chair rails, and the like. Use of molding of this general nature, and in and these particular areas, has become increasingly popular, and has generated substantial interest in the consumer market as well as in the homebuilder or office building market.

Although substantial interest has been generated focusing on the use and installation of various molding elements in existing homes/businesses as well as homes/businesses being professionally constructed, difficulties and drawbacks are frequently encountered in the installation of molding elements, which difficulties and drawbacks have not been resolved. In particular, it is well-known that molding elements or segments are typically constructed from wood, plastic or polymer materials, and require technical expertise for properly measuring and cutting the molding segments in the desired manner. Typically, one skilled in the finish carpentry trade is needed to obtain optimal results.

In general, the experienced tradesman or one having extraordinary technical skill is required for cutting the molding members to have the precisely desired length for having the adjacent segments abut each other in a manner which is visually acceptable. In particular, corners require mitered cuts of each segment to assure that the abutting segments are interconnected at a precisely 90° angle. Clearly, finish carpentry skills are required to cut precise lengths at accurate right angles in order to achieve desired results. In addition, in order to eliminate unsightly holes in finished surfaces caused by nails or screws, labor intensive filling of the holes is required.

One area which is of particular interest to consumers is in the area of remodeling, redesigning or improving existing structures. In this regard, existing molding which has been installed around door frames, window casements, and the like, are areas in which consumers frequently wish to upgrade or retrofit in order to produce a new, aesthetically pleasing, visual result. Although it is possible to remove existing molding around doors and windows, this process is extremely difficult and costly.

In particular, window and door assemblies generally comprise a number of frame elements which are assembled to form the window or door in the desired shape. In conventional remodeling, existing window or door frames must frequently be removed in order to install new window or door frames. In some instances, the removal of window or door frames may result in deformation being caused to components thereof, preventing the reuse of any existing structures. Furthermore, the complete removal of existing window and door frames with its associated molding requires substantial labor intensive effort due to the need to remove nails and/or repair any destruction caused by removing components secured in place by adhesives.

An additional problem found in prior art constructions is a requirement that molding components are mounted in place by use of adhesives or fastening materials such as nails. In particular, the use of nails causes unsightly holes to be formed in the molding members, which are incapable of being totally hidden, or require labor intensive efforts to obscure, and result in unsightly and unpleasant visual effects. In addition, the use of adhesives adds an additional level of difficulty to the installation process, often causing unwanted spattering and drops to be formed which are difficult to remove. Furthermore, the material employed for adhesives is often corrosive and/or toxic, thereby requiring special treatment and handling, as well as being environmentally unfriendly.

Although substantial effort has been expended in developing prior art products which have attempted to reduce or eliminate these problems, no prior art system has been capable of eradicating these problems. Consequently, molding installation occurring today continues to suffer from all of the drawbacks and difficulties detailed above.

Therefore, it is a principal object of the present invention to provide a retrofit decorative molding system which is easily employed to redecorate or retrofit existing molding installations with ease and simplicity.

Another object of the present invention is to provide a retrofit decorative molding system having the characteristic features described above which is quickly and easily installed by both professionals and homeowners and provides error free, aesthetically pleasing results.

Another object of the present invention is to provide a retrofit decorative molding system having the characteristic features described above which virtually eliminates any gaps, holes, or other visually unappealing defects commonly found in prior art constructions.

Another object of the present invention is to provide a retrofit decorative molding system having the characteristic features described above which is employed without requiring the removal of any exisiting molding components.

Another object of the present invention is to provide a retrofit decorative molding system having the characteristic features described above which is capable of being installed without requiring the formation of any mitered edges or abutting edges.

Another object of the present invention is to provide a retrofit decorative molding system having the characteristic features described above which is capable of being installed without requiring any adhesives, chemical-based fasteners, and/or environmentally unfriendly compositions.

Other and more specific objects will in part be obvious and will in part appear hereinafter.

### SUMMARY OF THE INVENTION

By employing the present invention, all of the difficulties and drawbacks found in prior art installations for redesigning molding systems employed around windows, doors, and the like are overcome and a retrofit molding system is achieved which is capable of being quickly and easily installed in any desired location by unskilled individuals, without requiring the use of mitered corners, abutting junctures, nails, adhesives, and the like. In accordance with the present invention, this unique, and easily installed, retrofit molding system employs a plurality of supporting brackets which are quickly and easily mounted to existing molding strip surfaces and are constructed for receiving and supportingly retaining any desired new, visually distinctive, decorative substitute molding strips. In this regard, the new, substitute molding strips are formed in a wide variety of decorative and visually distinctive appearances in order to satisfy the desires of any individual for a visually distinctive and aesthetically pleasing appearance.

In addition, the retrofit molding system of the present invention incorporates corner forming assemblies which are quickly and easily mounted in the corners of every window, door, or other area in which the retrofit system is installed. By employing the corner forming assemblies of the present invention, the need for mitering the newly installed, retrofit molding systems is completely eliminated and the need for a high level of technical skill is avoided.

In addition, by eliminating the need for any mitered corners, the presence of any gaps or unsightly abutment joints in the newly installed system are completely avoided, as well as any unsightly nail or screw holes in visible surfaces. By employing the combination of the components forming the retrofit molding system of the present invention, any desired location can be quickly and easily redecorated with a completely installed retrofit molding system for enhancing the visual and aesthetic appeal of any window, door, or other similar area.

In accordance with the present invention, any desired visual configuration for redesigning the molding surrounding windows, doors, and the like is quickly and easily achieved in any desired location without requiring the existing molding to be removed or the door frame assembly or window casement assembly being reconstructed. Furthermore, by employing the retrofit molding system of the present invention, the use of adhesives, nails or other fastening elements which would be visible are also eliminated.

In the present invention, support brackets are employed which are quickly and easily mounted to the existing molding strips by employing threaded screw members. Once the brackets are mounted in position, the desired, newly selected, decorative molding strips are quickly and easily securely affixed to the support brackets. In addition, mitering of abutment joints are totally eliminated by employing corner mounted support brackets or clips and fully constructed corner block covers which are quickly and easily mounted to the supporting clips/brackets to complete the visual appearance of the corners.

By employing preformed corner assemblies, which comprise the clip/brackets and the corner covers, a visually distinctive, aesthetically pleasing, corner structure is realized without requiring any molding strips to be cut, abutted to each other, or mitered. As a result, ease of installation is realized, as well as a professionally completed, visually pleasing appearance which can be obtained by any individual even with unskilled installers.

In the present invention, each of the retrofit molding strips, as well as the corner block covers are constructed in a wide variety of decorative, visually distinctive configurations. As a result, individuals are able to select from numerous product choices in order to achieve a retrofit molding system installation which satisfies the personal desires of the consumer. In this way, any desired visual appearance for a particular door, window, or other area is capable of being satisfied, with a complete installation of the retrofit decorative molding system of the present invention being completed quickly and easily, without requiring the use of nails, adhesives, or any other undesirable fasteners. Furthermore, the final installation is devoid of any mitered joints, abutting edges, visible holes, as well as the gaps or separations which typically occur in these constructions.

Furthermore, by employing the present invention, an individual is able to change or alter the retrofit molding system in its entirety after its installation. Since the newly installed decorative molding strips and corner block covers are all mounted in position by being secured to support bracket members, an individual is able to change the visual appearance of any molding system installed about windows or doors with ease and simplicity by merely removing the decorative elements after installation and mounting a new system with a totally different aesthetic visual appearance as a substitute therefor. In this way, decorative touches in a particular room or throughout an entire home can be altered at will, without requiring extensive or inexpensive reconstruction costs.

The invention accordingly comprises an article of manufacture possessing the features, properties, and relation of elements which will be exemplified in the article hereinafter described, and the scope of the invention will be indicated in the claims.

### THE DRAWINGS

For a fuller understanding of the nature and objects of the invention, reference should be had for the following detailed description, taken in connection with the accompanying drawings, in which:

FIG. 1 is an exploded perspective view of a fully installed retrofit molding system in accordance with the present invention mounted to any existing doorway;

FIG. 2 is a perspective view of a decorative panel which forms a component of the retrofit decorative molding system of FIG. 1;

FIG. 3 is an end in view of the decorative panel of FIG. 2;

FIG. 4 is a perspective view of a panel supporting clip forming a component of the retrofit molding system of FIG. 1;

FIG. 5 is a side elevation view of the panel supporting clip of FIG. 4;

FIG. 6 is a cross-sectional plan view of a typical installation of the decorative panel and panel supporting clip mounted to the molding of a conventional framed doorway;

FIG. 7 is a perspective view of an alternate panel supporting clip for use in the retrofit decorative molding system of the present invention;

FIG. 8 is a cross-sectional plan view of a typical installation employing the alternate panel supporting clip and decorative panel mounted to a reduced width molding framed doorway;

FIG. 9 is a perspective view, partially broken away, of the retrofit decorative molding system of the present invention fully installed in the corner of a typical doorway;

FIG. 10 is an exploded perspective view of the retrofit decorative molding system installation of FIG. 9;

FIG. 11 is a front perspective view of the corner forming clip/bracket which forms a component of the retrofit decorative molding system of FIG. 1;

FIG. 12 is a rear perspective view of the corner forming clip/bracket of FIG. 11;

FIG. 13 is a front perspective view of the corner forming block cover which forms a component of the retrofit decorative molding system of FIG. 1; and

FIG. 14 is a rear perspective view of the corner forming block cover of FIG. 13.

### DETAILED DESCRIPTION

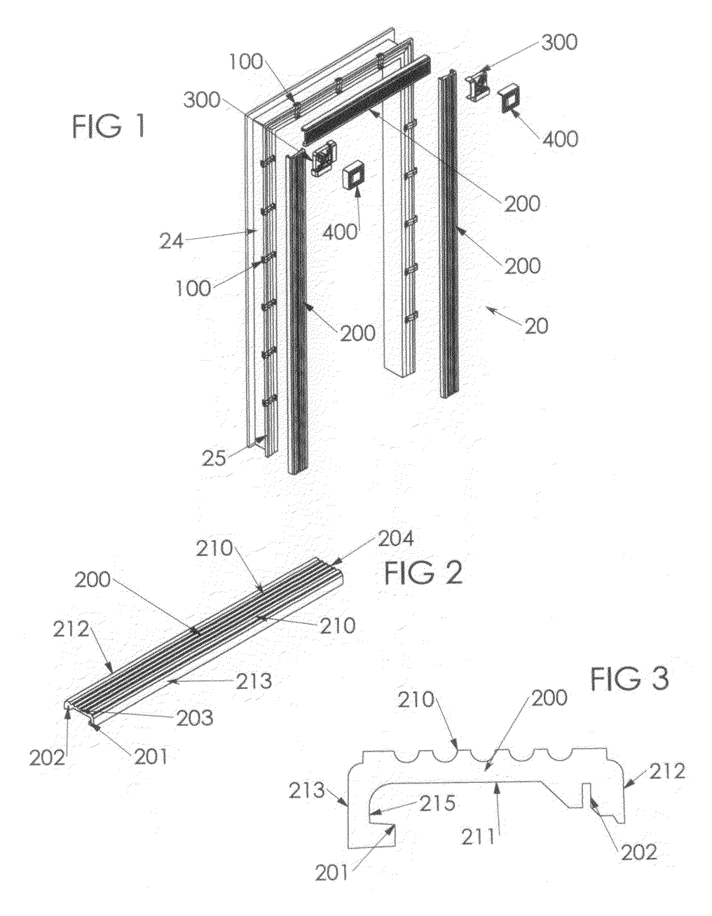

By referring to FIGS. 1-14, along with the following detailed discussion, the preferred construction and operation of the retrofit decorative molding system of the present invention can best be understood. Although this disclosure fully details the preferred embodiment of the present invention, alterations and variations in the embodiment provided herein can be made without departing from the scope of this invention. Consequently, it should be understood that the disclosure of the embodiment shown in FIGS. 1-14 and discussed in the following disclosure are provided for exemplary purposes only and should not be interpreted in a limiting sense.

In FIG. 1, a typical installation of retrofit decorative molding system 20 of the present invention is provided, depicting the complete assembly of molding system 20 to a door frame. In FIGS. 1, a door frame is depicted for exemplary purposes only, and it should be understood that virtually a identical retrofit decorative molding system 20 would be installed in a substantially identical manner about a window casement, or any other similar construction.

In the installation depicted in FIG. 1, all of the components forming retrofit decorative molding system 20 are shown in association with pre-existing door frame assembly 24. In this regard, all of the principal components forming door frame assembly 24 are shown with pre-existing molding 25 representing a principal component of door frame assembly 24. Furthermore, as is evident from the foregoing detailed discussion, the particular visual appearance employed for retrofit molding system 20 and shown in FIGS. 1-14 represent one configuration of numerous alternate configurations, each of which provide a unique and distinctive visual appearance.

In the preferred construction of the present invention, retrofit decorative molding system 20 comprises elongated, longitudinally extending decorative panels 200, panel supporting clips 100, corner forming clip or bracket 300, and corner forming block cover 400. By employing these components and mounting these components in the manner shown in the Figures and detailed below, the construction, installation, and use of retrofit decorative molding system 20 of the present invention is achieved quickly and easily, without requiring trained personnel for its use and installation. Furthermore, as detailed below, adhesive, nails, and visible fastening means in the outside surface are eliminated, as well as the need for mitering any component.

In FIGS. 2 and 3, the preferred construction for decorative panel 200 is shown. As depicted, decorative panel 200 comprises an elongated, longitudinally extending, substantially straight length of pre-formed material incorporating top surface 210 which incorporates particularly desired decorative appearance formed therein. As discussed above, top surface 210 is constructed with numerous alternate configurations, each of which provides a unique and distinctive visual appearance. In this way, any desired visually distinctive, aesthetically pleasing decorative design desired by a consumer can be provided, with the retrofit decorative molding system 20 effectively establishing the precise visual appearance sought by the consumer.

Typically, decorative panel 200 is constructed in uniform elongated lengths, which are then cut to a particular desired dimension. In this regard, the installer would merely measure the length required for covering molding 25 from the floor to the top of the doorway just below the pre-existing mitered corner and then cut the preformed length of panel 200 to the desired dimension. As a result, decorative panel 200 incorporates substantially flat terminating ends 203 and 204.

In the preferred embodiment, decorative panels 200 are formed from closed cell polymer materials which are molded in order to enable a wide variety of alternate configurations, designs, and visual appearances to be achieved with reasonable manufacturing costs. In this regard, although virtually any closed cell polymer can be employed, it has been found that polyurethane represents the preferred material of choice.

In the preferred construction, decorative panel 200 incorporates bottom surface 211, and side surfaces 212 and 213. In addition, elongated, longitudinally extending slot 202 is formed in bottom surface 211, spaced inwardly from side surface 212. Furthermore, panel 200 incorporates flange 201 formed at the terminating end of side surface 213 with flange 201 and extending inwardly therefrom to form L-shaped abutment surface 215. As detailed below, by employing this construction for decorative panel 200, decorative panel 200 is quickly and easily securely affixed to panel supporting clips 100, for achieving the complete installation of retrofit decorative molding system 20 both quickly and easily.

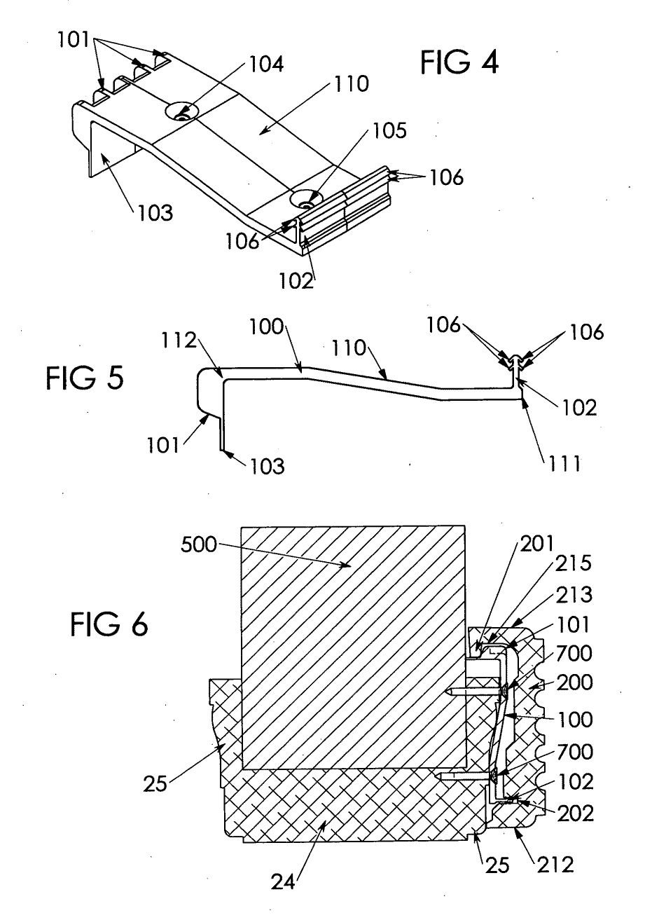

In FIGS. 4 and 5, the preferred embodiment for panel supporting clips 100 is depicted. And shown therein, panel supporting clip 100 comprises a single, substantially rectangular shaped plate member 110 which incorporates a plurality of interconnected sloping sections, along with screw receiving holes 104 and 105 formed therein. In addition, plate member 100 is constructed with an overall sloping shape in order to accommodate the typical sloped configuration of conventional molding 25 affixed to door frame assemblies 24. Although the precise configuration of molding 25 would typically vary in its visual appearance, the overall sloping shape employed is generally consistent, with the configuration of plate member 110 being constructed for accommodating virtually all molding configurations.

In addition, plate member 110 incorporates proximal terminating end 111 and distal terminating end 112. Proximal terminating end 111 incorporates flange or wall 102 mounted thereto, substantially at right angles to terminating end 111 of plate member 110 and extending in a first direction relative to plate member 110. Furthermore, flange 102 incorporates a plurality of outwardly extending barb members 106 formed at the terminating end thereof.

In completing the construction of plate member 110 of panel supporting clip 100, distal end 112 incorporates wall 103 mounted thereto at substantially right angles therewith, with wall 103 extending from distal end 112 in a direction opposite from flange 102 of proximal end 111. Furthermore, wall 103 incorporates a plurality of outwardly extending locking flanges 101 which, as further detailed below, cooperate with L-shaped abutment surface 215 of flange 201 to securely retain decorative panel 200 in the precisely desired position. In the preferred construction, the plurality of flanges 101 are affixed to wall 103 at substantially right angles thereto, with each flange 101 being positioned in juxtaposed, parallel, spaced, relationship with each other.

By referring to FIGS. 1 and 6, along with the following detailed disclosure, the rapid, easy, and trouble-free installation of decorative panel 200 to door frame assembly 24 can best be understood. Furthermore, as is evident from this disclosure, decorative panel 200 is securely mounted to pre-existing door frame assembly 24 without requiring the use of any externally visible nails, screws, adhesives, or other fastening means.

As a result, once installed, decorative panels 200 are completely free of any unsightly holes formed by such fastening means as well as being completely free of any gaps, cracks, or crevices which might otherwise exist using prior art installations. Furthermore, the use of any undesirable adhesives is also completely avoided, thereby providing an installation which is environmentally friendly.

As depicted, a plurality of panel supporting clips 100 are mounted to existing molding 25 of door frame assembly 24. Preferably, the plurality of panel supporting clips 100 are mounted in spaced intervals along the length of molding 25, in order to provide secure, supporting, locking engagement of decorative panels 200 with door frame assembly 24. In securely affixing supporting clips 100 to molding 25, screws 700 are preferably employed which are merely inserted through screw receiving holes 104 and 105 of plate member 110 and threadedly engaged with door frame assembly 24 as well as wall and stud assembly 500 to which door frame assembly 24 is affixed. Once each of the plurality of panel supporting clips 100 are mounted in place, each pre-cut length of decorative panel 200 is ready to be securely affixed to clips 100.

In order to securely mount decorative panel 200 to panel supporting clips 100, the user is only required to position inwardly extending flange 201 below the plurality of locking flanges 101 of clip 100, effectively bringing L-shaped abutment surface 215 into locking engagement with flanges 101. Once in this position, side surface 213 of decorative panel 200 is securely mounted to supporting clip 100.

Thereafter, the entire affixation process is quickly and easily completed by inserting flange 102 of clip 100 onto longitudinally extending slot 202 of panel 200. This insertion process brings barbed members 106 of flange 102 into frictional, secure, locking engagement with the walls of slot 202. When this quick, simple, and easily achieved mounting process is completed, decorative panel 200 is securely affixed to panel supporting clips 100 and pre-existing door frame assembly 24.

In installing retrofit decorative molding system 20 of the present invention to door frame assembly 24, each of the two additional decorative panels 200 are mounted to door frame assembly 24 using the identical process detailed above. Once all of the decorative panels 200 have been fully installed, retrofit decorative molding system 20 is almost complete. The only remaining elements to be mounted to door frame assembly 24, in order to complete the entire installation, are the two corner forming clips/brackets 300 and corner forming covers 400, the installation details of which are provided below.

As is evident from the foregoing detailed discussion, the installation of each decorative panel 200 is achieved quickly and easily, without requiring the use of any adhesives, nails, or screw members for fastening decorative panels 200 to door frame assembly 24. As a result, unsightly nail or screw holes are completely avoided, as well as any requirement that adhesives be used. In this way, an environmentally friendly installation system is realized, as well as achieving a complete installation which is aesthetically pleasing and visually satisfying, while also being accomplished quickly and easily.

Furthermore, by employing retrofit decorative molding system 20 of the present invention, previously existing door frame assembly 24 remains completely intact, without any requirement that any portion of existing door frame assembly 24 needs to be disassembled. As a result, the installation of retrofit decorative molding system 20 of the present invention is accomplished quickly and expeditiously, while also being completed with substantially less labor and cost.

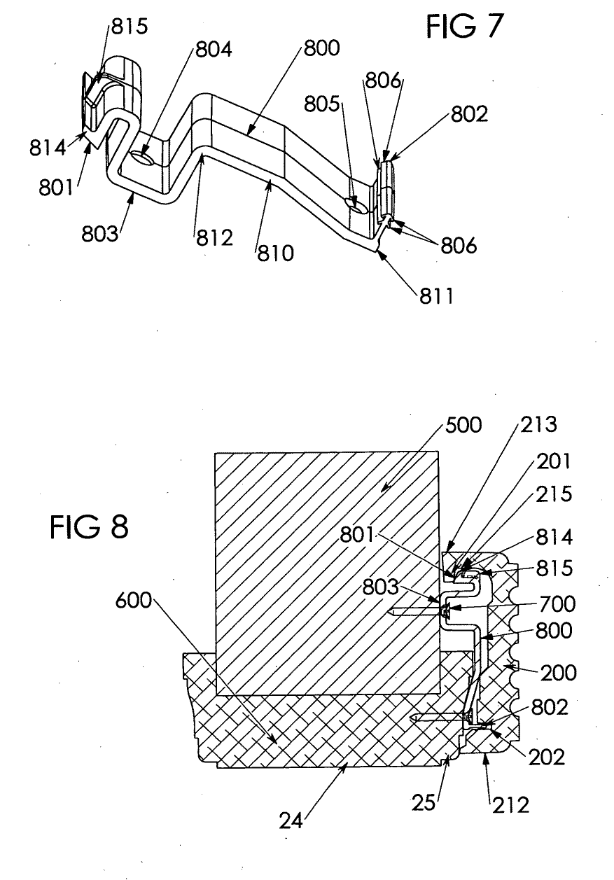

In some installations, door and/or window molding comprises a width which is substantially smaller than the width of more typical molding. In other to enable retrofit molding system 20 of the present invention to be quickly and easily affixed to all existing molding 25, regardless of the width of the molding, an alternate panel supporting clip construction is employed. By referring to FIGS. 7 and 8, along with the following detailed disclosure, the construction and installation of alternate panel supporting clip 800 can best be understood.

In this alternate construction, panel supporting clip 800 incorporates plate member 810 which comprises a plurality of interconnected sloping sections to accommodate the typical sloped configuration of molding 25 affixed to door frame assembly 24. In addition, plate member 800 comprises proximal terminating end 811 and a distal end 812 which is interconnected with U-shaped portion 803. Since the reduced width molding 25 is typically unable to support plate member 810 in its entirety, U-shaped extension portion 803 is formed as an integral component of support clip 800, preferably being interconnected to distal end 812.

Alternate panel supporting clip 800 also incorporates L-shaped extension 801 which is interconnected at one end to U-shaped portion 803 and terminates at its opposed end with outwardly extending flange 814. Preferably, outwardly extending wall 815 is also formed on the outside surface of L-shaped extension 801. In addition, terminating end 811 of plate member 810 of clip 800 incorporates upstanding flange 802 extending perpendicularly from plate member 810, with a plurality of barbed members 806 extending outwardly therefrom. Finally, clip 800 incorporates screw receiving holes 804 and 805 formed therein which cooperate with screw members to secure alternate panel supporting clip 800 to pre-existing door frame assembly 24.

Using the construction detailed above, a plurality of alternate panel supporting clips 800 are quickly and easily installed to existing molding 25 of door frame assembly 24. In this regard, the plurality of panel supporting clips 800 are mounted to reduced width molding 25 in spaced intervals along the length of molding 25, in order to provide secure, supporting, locking engagement of decorative panels 200 with door frame assembly 24 having reduced width molding 25. In securely affixing supporting clips 800 to reduced width molding 25, screws 700 are preferably employed and are merely inserted through screw receiving holes 804 and 805 of clip 800.

In this regard, screw member 700 inserted through receiving hole 805 is threaded directly into reduced width molding 25. However, screw member 700 inserted through receiving holes 804 extends beyond the width of the molding 25 and is incapable of being threadedly engaged with molding 25. However, due to the placement of screw receiving hole 804 in U-shaped portion 803 as well as the construction of U-shaped portion 803, the bottom surface of U-shaped portion 803 is in contact with wall/stud assembly 500 and enables screw member 700 to be threadedly engaged directly in wall/stud assembly 500. In this way, alternate panel supporting clip 800 is quickly and easily mounted to door frame assembly 24, while still enabling molding 25 to be retained on door frame assembly 24 without any removal thereof. Once each of the plurality of alternate panel supporting clips 800 are mounted in place, the pre-cut lengths of decorative panel 200 are ready to be securely affixed to clips 800.

In order to securely mount decorative panels 200 to alternate panel supporting clips 800, the user is only required to position inwardly extending flange 201 of panel 200 below outwardly extending flange 814 of L-shaped extension 801 of clip 800, effectively bringing L-shaped abutment surface 215 into locking engagement with flange 814 and outwardly extending wall 815. Once in this position, side surface 213 of decorative panel 2000 is securely mounted to supporting clip 800.

Thereafter, the entire affixation process is quickly and easily completed by inserting upstanding flange 802 of clip 800 into longitudinally extending slot 202 of panel 200. This insertion process brings barbed members 806 of flange 802 into frictional, secure, locking engagement within slot 202. When this quick, simple, and easily achieved mounting process is completed, decorative panel 200 is securely affixed to alternate panel supporting clips 800 and pre-existing door frame assembly 24.

Once all of the decorative panels 200 are mounted to alternate clips 800, the installation of retrofit decorative molding system 20 is almost complete. As is evident from the foregoing detailed disclosure, the installation of decorative panels 200 are achieved quickly and easily, without requiring the use of any adhesives, nails, or screw members for fastening decorative panels 200 to door frame assembly 24. As a result, unsightly nail or screw holes are completely eliminated along with any requirement that adhesives be employed. In this way, an environmentally friendly installation is realized, as well as the attainment of a complete installation which is aesthetically pleasing and is visually satisfying, while also being accomplished with speed and efficiency.

Furthermore, by employing retrofit decorative molding system 20 of the present invention, previously existing door frame assembly 24 with reduced width molding 25 remains completely intact, without any requirement that any portion of existing door frame assembly 24 needs to be disassembled. As a result, substantially less labor and costs are required in achieving a complete installation of retrofit molding system 20 of the present invention.

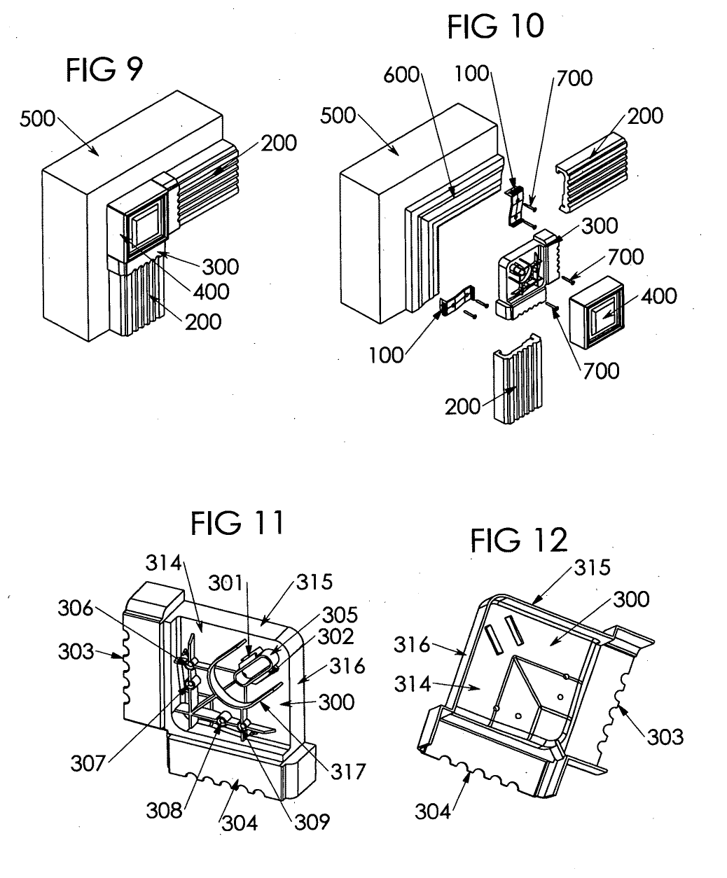

The entire installation of retrofit decorative molding system 20 of the present invention is completed by mounting corner forming clip/bracket 300 and corner forming block cover 400 to each corner of doorframe assembly 24. By referring to FIGS. 9-14, along with the following detailed discussion, the construction of each of these components, along with their rapid, trouble-free installation can best be understood.

As depicted, corner forming clip/bracket 300 comprises a preformed bracket assembly having a supporting base 314 and is constructed for being quickly and easily securely affixed to the corner forming portions of molding 25. Preferably, corner forming clip/bracket 300 is formed from plastic material which has been molded to achieve a construction for being quickly and easily positioned in overlying relationship with corner forming molding 25 and is secured thereto by screws 700. In this regard, corner forming clip/bracket 300 incorporates screw receiving holes 306, 307, 308, and 309 formed on base 314.

In order to enable corner forming clip/bracket 300 to be quickly and easily mounted in place on molding 25, clip/bracket 300 incorporates side forming flanges 315 and 316 which extend from base 314. In addition, flanges 315 and 316 are configured for contacting and peripherally surrounding the side edges of corner forming molding 25 while positioning base 314 in overlying relationship with corner forming molding 25.

Furthermore, clip/bracket 300 incorporates end extensions 303 and 304 which extend from base of 314 and are constructed for overlying and covering the terminating ends of decorative panels 200 after being affixed to doorframe assembly 24. In this way, the terminating ends of decorative panels 200 are not visible, and no visible gap or other opening exists between decorative panels 200 and corner forming block cover 400 and/or corner forming clip/bracket 300.

In order to enable corner forming block cover 400 to be quickly and easily securely mounted to corner forming clip/bracket 300, corner forming clip/bracket 300 incorporates upstanding oval shaped wall member 305 mounted to the top surface of base 314. In the preferred construction, upstanding, oval shaped wall member 305 comprises outwardly extending locking plates 301 and 302 extending from opposed walls of oval shaped wall member 305. As detailed below, outwardly extending plates 301 and 302 provide frictional, locking interengagement with a corresponding locking wall formed on corner forming seam cover 400. In this way, corner forming seam cover 400 and corner forming clip/bracket 300 are quickly and easily placed in secure locked engagement with each other in order to complete the assembly of retrofit decorative molding system 20.

In the preferred embodiment, corner forming clip/bracket 300 also incorporates an upstanding U-shaped wall 317 which is mounted to base 314 in cooperating spaced relationship with oval shaped wall member 305. In this way, a rigid construction is realized.

In its preferred construction, corner forming seam cover 400 comprises a generally rectangular shape which is established by plate 405. In addition, plate 405 has a rear surface 406 and a front, forward facing surface 407. Preferably, plate 405 also incorporates side forming flanges 408 and 409 which extend substantially perpendicularly from two adjacent side edges of plate 405. Side edges 408 and 409 are constructed and are positioned for being placed in spaced, cooperating association with flanges 315 and 316 of clip/bracket 300 when corner forming seam cover 400 is mounted in place.

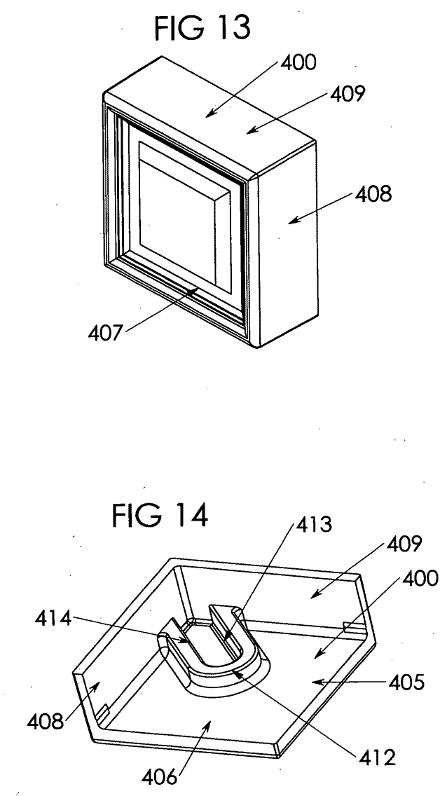

In order to provide a visually interesting, aesthetically pleasing, decorative visual appearance to each corner of the doorframe or window frame being reconstructed, corner forming seam cover 400 incorporates a unique, decorative, visually interesting surface construction on forward, front facing surface 407. In this regard, virtually any desired visual configuration can be employed for the exposed panel of front surface 407. As depicted in FIG. 13, a raised panel configuration is shown for exemplary purposes only. However, other configurations such as interwoven strips, rosettes, logos, aesthetic shapes, designs, florettes, and the like may all be employed if desired. In addition, a miter simulating configuration can also be employed in order to provide the doorway or window frame with the visual appearance of a mitered joint.

Regardless of the configuration employed for surface 407 of corner forming seam cover 400, it is important to note that in employing retrofit decorative molding system 20 of the present invention no components used in the construction need to be cut with a mitered configuration, as required in typically installed doorway and window frame configurations. Using the present invention, straight cuts and cover elements are employed which are easily cut and mounted in place, by individuals having ordinary skill. Furthermore, by employing the present invention, installation ease and convenience is also realized.

It is also important to recognize that the use of the present invention completely eliminates any need for adhesives while also eliminating the presence of any gaps or crevices that typically occur in prior art installations. In this way, an aesthetically pleasing and visually satisfying construction is achieved. Furthermore, no component employed in the present invention is secured in place by nails or screws which results in visible surface holes or apertures being formed. As a result, the aesthetic pleasing result of the present invention is further enhanced.

The construction of corner forming seam cover 400 is completed by incorporating locking wall 412 on rear surface 406 of plate 405. In its preferred construction, locking wall 412 extends from surface 406 substantially perpendicularly therefrom and incorporates inside wall 413 and outside wall 414.

As discussed above, inside wall 413 is constructed with a dimension for being mounted in cooperating association with oval shaped wall member 305 and being secured in place by engagement with locking plates 301 and 302. By employing this construction, corner forming seam cover 400 is quickly and easily securely affixed to corner forming clip/bracket 300 by advancing locking wall 412 into secure locking engagement with oval shaped wall member 305. Once in position, these components are secured and maintained in engagement with each other due to the frictional contact between the locking elements thereof. As a result, corner forming seam cover 400 is quickly and easily mounted in place, completing the desired installation of retrofit decorative molding system 20 of the present invention.

It will thus be seen that the objects set forth above, among those made apparent from the preceding description, are efficiently obtained and, since certain changes may be made in the above article without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Having described our invention, what we claim as new and desire to secure by Letters Patent is:

1. A retrofit decorative molding system constructed for being quickly and easily mounted in position in overlying, cooperating relationship with existing molding mounted about doorways, windows, and the like, for effectively covering the existing molding and creating an entirely new, visually distinctive appearance without requiring disassembly or reconstruction, said a retrofit decorative molding system comprising:
A. a plurality of supporting clips mounted to the existing molding in spaced relationship with each other, with each of said supporting clips comprising:
a) an elongated, substantially flat plate member constructed for overlying contacting relationship with the molding substantially throughout the entire length of said plate member,
b) a flange mounted at a first end of said plate member and extending substantially perpendicularly therefrom in a first direction and incorporating barbed elements extending outwardly from the terminating end of said flange, and
c) a wall member mounted to the second end of the plate member and extending substantially perpendicularly therefrom in a second direction, said second direction being opposite the first direction and incorporating a plurality of locking flanges extending outwardly from the surface of said wall member;
B. a plurality of elongated, longitudinally extending decorative panels, each comprising:
a) an outside surface having an aesthetically pleasing decorative construction for providing a desired visual effect to the doorway or window frame,
b) an inside surface comprising an inwardly extending flange formed along a first side surface of the decorative panel and constructed for cooperative, locking engagement with the locking flanges of the supporting clips and an elongated, longitudinally extending slot formed in the inside surface of the decorative panel inwardly of a second side surface of the decorative panel, said elongated slot being constructed for mating locking interengagement with the flange of the supporting clips and the outwardly extending barbed elements thereof;
C. a plurality of corner forming clips/brackets constructed for being mounted to each corner of the doorway or window frame in cooperating association with the adjacent decorative panels; and
D. a plurality of corner forming seam covers constructed for being quickly and easily securely mounted to a corner forming clip/bracket and incorporating a decorative, visually pleasing, aesthetically satisfying outer surface for completing the retrofit decorative molding system of the present invention;
whereby the molding of any existing doorway or window frame assembly can be quickly and easily covered in its entirety for achieving a new, unique, and distinctive visual appearance without requiring any removal or reconstruction of the existing structure.

2. The retrofit decorative molding system defined in claim 1, wherein each plate member of each supporting clip comprises an overall sloping shape constructed for enabling said plate member to contact the surface of the molding throughout the length of the plate member.

3. The retrofit decorative molding system defined in claim 1, wherein each plate member comprises a plurality of screw receiving apertures formed therein for enabling screw means to be inserted therethrough and threadedly engaged with the molding of the doorway or window for securely affixing the supporting clip to the molding.

4. The retrofit decorative molding system defined in claim 3, wherein the plurality of locking flanges extending outwardly from the surface of the wall member of the supporting clip are further defined as extending substantially perpendicularly to the wall member with each of the locking flanges being in juxtaposed, spaced, relationship with each other.

5. The retrofit decorative molding system defined in claim 1, wherein the plurality of elongated, longitudinally extending decorative panels are further defined as comprising an overall length constructed for covering the existing molding extending between one or more selected from the group consisting of two adjacent corners, and a corner and the floor.

6. The retrofit decorative molding system defined in claim 1, wherein the existing molding of the doorway or window comprises an overall width which is substantially less than the overall width of typical molding and the retrofit decorative molding system comprises a plurality of supporting clips constructed for being mounted to the existing reduced with molding in spaced relationship with each other, with each of said supporting clips comprising:
a) an elongated plate member constructed for overlying contacting relationship with the reduced width molding,
b) a flange mounted at a first end of said plate member and extending substantially perpendicularly there from in a first direction and incorporating barbed elements extending outwardly from the terminating end of said flange,
c) a U-shaped extension section affixed on a first side thereof to a second end of said plate member and constructed for contacting the wall adjacent the reduced width molding, and
d) an L-shaped extension affixed to a second side of said U-shaped extension section and comprising an outwardly extending flange positioned for locking interengagement with the inwardly extending flange of the decorative panel in order to provide the desired locking interengagement therewith,
whereby a supporting clip construction is achieved which is capable of being mounted to reduced width moldings and enabling full with decorative panels to be securely affixed thereto.

7. The retrofit decorative molding system defined in claim 6, wherein the elongated plate member of the supporting clip comprises a screw receiving aperture formed therein for enabling the plate member to be securely affixed to the reduced width molding, and the U-shaped extension section incorporates a screw receiving aperture formed therein for enabling a portion of the U-shaped extension to be securely mounted to a wall directly adjacent the reduced width molding.

8. The retrofit decorative molding system defined in claim 1, wherein said elongated, longitudinally extending decorative panels are further defined as being constructed from molded, thermoplastic material.

9. The retrofit decorative molding system defined in claim 8, wherein said thermoplastic material is further defined as comprising polyurethane.

10. The retrofit decorative molding system defined in claim 1, wherein each corner forming clip/bracket is further defined as comprising a molded housing incorporating:
a) a substantially flat, generally rectangular support surface dimensioned for being affixed in overlying engagement with the existing molding forming the corner of the doorway or window,
b) two flanges extending rearwardly from a first pair of adjacent edges of the support surface and constructed for contacting the side edges of the molding forming the corner of the doorway or window,
c) decorative plates extending from a second pair of adjacent edges of the support surface and constructed for overlying the decorative panels affixed to the existing molding adjacent the corner and constructed for visually shielding the terminating edges of the decorative molding for preventing any gaps or edges to be visible, and
d) locking means formed on a top surface of the support plate and constructed for providing holding interengagement with the corner forming seam cover and enabling the corner forming seam cover to be quickly and easily securely affixed thereto.

11. The retrofit decorative molding system defined in claim 10, wherein the locking means is further defined as comprising an oval shaped upstanding wall member incorporating two outwardly extending locking plates formed on opposed walls of the oval shaped wall member and positioned for providing holding frictional engagement with a cooperating locking wall formed on the corner forming seam cover affixed thereto.

12. The retrofit decorative molding system defined in claim 11, wherein the locking means further comprises a substantially U-shaped, upstanding wall member formed on the top surface of the support plate in spaced, partial peripheral surrounding relationship with the oval shaped wall member, positioned for contacting a rear surface of the corner forming seam cover and engaging the locking wall of the corner forming seam cover.

13. The retrofit decorative molding system defined in claim 12, wherein each corner forming seam cover is further defined as comprising a generally rectangular shaped molded plate constructed for cooperating, overlying engagement with the corner forming clip/bracket and incorporating:
a) an outer surface and an inner surface, said outer surface incorporating a decorative, visually pleasing, aesthetically satisfying construction,
b) two flanges extending rearwardly from two adjacent edges of the plate, and
c) a locking wall formed on the inner surface of the plate, extending upwardly from the inner surface, and comprising a generally U-shaped construction.

14. The retrofit decorative molding system defined in claim 13, wherein said locking wall is further defined as comprising an inside surface dimensioned for mating, peripherally surrounding engagement with the oval shaped upstanding wall member of the clip/bracket and an outer surface dimensioned for mating, contacting, frictional engagement with the U-shaped wall member of the clip/bracket, whereby positioning the corner forming seam cover and engagement with the corner forming clip/bracket enables the components to be securely lockingly engaged and supportingly maintained with each other.

15. The retrofit decorative molding system defined in claim 14, wherein the locking wall of the corner forming seam cover is secured in frictional interengagement with the oval shaped upstanding wall member of the clip/bracket due to the engagement of the outwardly extending plate members formed on the outer surface of the oval shaped wall members.
